(19) United States
(12) Patent Application Publication
(10) Pub. No.: US 2016/0241556 A1
(43) Pub. Date: Aug. 18, 2016

(54) MUTUAL AUTHENTICATION WITH INTEGRATED USER MUSCLE MEMORY

(71) Applicant: QUALCOMM Incorporated, San Diego, CA (US)

(72) Inventor: Bjorn Jakobsson, Portola Valley, CA (US)

(21) Appl. No.: 14/624,184

(22) Filed: Feb. 17, 2015

(51) Int. Cl. H04L 29/06

(52) U.S. Cl. CPC H04L 63/0869; H04L 63/1483; H04L 63/102

(57) ABSTRACT

A method for mutual authentication between a client device and authentication server is provided whereby an account identifier is sent from the client device to the authentication server, and the authentication server provides the client device a plurality of starting symbols associated with the account identifier. The plurality of starting symbols are distinct for different account identifiers. Additionally, a sensory feedback profile associated with the account identifier may be sent by the authentication server to the client device. The same starting symbols and/or sensory feedback profile is used every time the account identifier and/or device identifier are used. The plurality of starting symbols and sensory feedback profile is not stored at the client device but instead provided each time by the authentication server upon entry of the account identifier. This prevents an attacker from being able to being able to provide the correct starting symbols and/or sensory feedback profile.

### BACKGROUND

1. Field

The present disclosure relates generally to authentication, and more particularly, to a method and apparatus for mutual authentication between a user and a service provider.

2. Background

Phishing is an identity-theft scam that tricks victims into thinking that they are on a legitimate website, usually a banking or financial website. Unknowingly, the victims would provide account numbers and credentials to the fraudulent website that is designed to have the same look and feel as a real website. This type of scam is estimated to cost victims hundreds millions of dollars per year.

A phishing scam starts when a scammer sends an email to an unsuspecting victim. The phishing email is often flagged with high urgency to induce the victim to take immediate action. The phishing email typically warns the victim that his account has been compromised and he must click on the link provided to log into his account and immediately change his password. Another common phishing email is a purported survey request from the victim's financial institution. The phishing email promises that upon completion of the short survey, the victim would receive a $20 credit, for example. However, in order to receive the money credit, the victim is required to provide his account information and credential in order for the bank to verify his identity and deposit the money into his account. Like all phishing emails, the phishing email provide a link to a fake website that mimics the look and feel of the real website.

The link in the phishing email, however, directs the victim to a fake website that looks substantially identical to the legitimate financial website. Once victim is on the fake website, the victim would unknowingly provide his username (e.g., account identifier) and password (e.g., security code) to the fake website by attempting to log into his account. Now armed with the victim account information and credential, the scammer logs into the legitimate financial website and transfers out the victim's assets.

Several attempts have been made by the banking industry to protect consumers from phishing scams. One of the commonly used anti-phishing methods is a method that employs a user selected graphic to indicate that the user is on a legitimate website. During account activation, the banking server would ask the user to select a picture or graphic to associate with the user's account. Once this step is completed, during a normal login procedure, the user selected graphic would appear next to the username and password interfaces after the user has entered the username. Typically, the password field is disabled or not visible until after the user has entered the username. Once the user entered his username, the banking server then retrieves the graphic associated with the user name and displays it next to the username or password field. This anti-phishing method aims to remind the user that a legitimate website would display the correct graphic associated with the user account. A phishing website would have no way of determining which graphic is associated with which account.

However, studies have shown that people tend to forget the selected graphic associated with their account or ignore the graphic altogether. Accordingly, a new and improved method for anti-phishing is needed.

### SUMMARY

People tend to forget the selected graphic associated with their account because the embedded graphic is passive and entirely non-interactive. Over time, people would ignore the graphic entirely because of the lack of interaction and passiveness. Accordingly, a new and improved method for anti-phishing is needed.

The improved method forces the user to interact with a starting set of symbols and/or sensory feedback during the password entering process. In this way, the user will have an elevated awareness of look and feel of the legitimate website thereby reducing the chance that the user will become a victim of a phishing scam. Accordingly, a system and method for mutual authentication is disclosed herein.

According to a first aspect an authentication server and method operational therein is provided. An account identifier of a user is obtained from a client device. A plurality of starting symbols associated with the account identifier are obtained and/or associated, wherein the plurality of starting symbols are distinct for different account identifiers and the same plurality of starting symbols is obtained every time the same account identifier is received from the client device. The plurality of starting symbols associated with the account identifier are sent to the client device.

Each symbol of the plurality of symbols may be at least one of an alphanumeric character, a pattern, a picture, a glyph, and a color. The account identifier may include a user identifier, account number, and/or user name.

The authentication server may also receive a device identifier from the client device, wherein the plurality of starting symbols associated with the account identifier is only obtained if the device identifier was previously associated with the account identifier. If the device identifier indicates that the client device was previously unassociated with the account identifier, the authentication server may send a plurality of new starting symbols to the client device. Otherwise, if the device identifier indicates that the client device was previously associated with the account identifier, the same plurality of starting symbols is obtained and/or sent.

A security code associated with the account identifier may also be obtained or received from the client device. The plurality of starting symbols may be randomly generated while guaranteeing that the plurality of starting symbols is distinct from the security code. The plurality of starting symbols may be associated, by the authentication server, with the account identifier.

In one example, each symbol of the plurality of starting symbols may be distinct from each corresponding symbol of the security code.

In another example, each symbol of the plurality of starting symbols may be selected from a set of ordered symbols, each symbol of the plurality of starting symbols is at least two symbols away in the set of ordered symbols from a corresponding symbol of the security code.

In one implementation, the authentication server may be adapted to send a sensory feedback profile associated with the account identifier to the client device, wherein the sensory feedback profile is configured to provide a sensory feedback response upon interaction with each symbol of the plurality of starting symbols.

According to one aspect, the sensory feedback profile may be generated by the authentication server and is associated with the account identifier, wherein the same sensory feedback profile is sent each time the account identifier is received by the authentication server.

According to yet another example, each symbol of the plurality of starting symbols may be associated with interactive interface portion of a user input interface, and a different sensory feedback response is associated with each interactive interface portion. The same sensory feedback profile may be used every time the device identifier indicates that the client device was previously associated with the account identifier.

According to various examples, the sensory feedback response may be one of a tactile response, a visual response, an audio response, or a combination of a tactile, a visual, or an audio response.

According to a second aspect a client device and method operational therein is provided. An account identifier of a user or account is sent to an authentication server. In response, a plurality of starting symbols associated with the account identifier is received, wherein the plurality of starting symbols are distinct for different account identifiers and the received plurality of starting symbols are the same every time the account identifier is sent from the client device. The plurality of starting symbols may then be displayed within an interactive input interface to allow the user to select a security code. In one example, the interactive input interface is a rotating interface configured to individually change each symbol of the plurality of starting symbols upon interaction by a user. If the selected security code is successfully authenticated by the authentication server, then access to an account associated with the account identifier may be obtained or gained.

According to one feature, a sensory feedback profile associated with the account identifier may be obtained from the authentication server. A sensory feedback response may be provided according to the sensory feedback profile each time the user interacts with the interactive user interface to change one of the displayed starting symbols. The same sensory feedback profile is received by the client device every time a same device identifier and account identifier are sent to the authentication server. Each symbol of the plurality of starting symbols may be associated with a different interactive interface portion of a user input interface, and a different sensory feedback response is associated with each interactive interface portion.

### BRIEF DESCRIPTION OF THE DRAWINGS

FIG. 1 illustrates a phishing scheme and why certain approaches fail to prevent it from happening frequently.

FIG. 2 illustrates an exemplary anti-phishing feature on a website.

FIG. 3 illustrates an exemplary anti-phishing feature on a user interface in accordance to one aspect.

FIG. 4 illustrates a first exemplary processes for performing mutual authentication in accordance with one or more aspects.

FIG. 5 illustrates a second exemplary processes for performing mutual authentication in accordance with one or more aspects.

FIG. 6 illustrates a third exemplary processes for performing mutual authentication in accordance with one or more aspects.

FIG. 7 illustrates a fourth exemplary processes for performing mutual authentication in accordance with one or more aspects.

FIG. 8 illustrates a first exemplary user interface for performing mutual authentication in accordance with one or more aspects.

FIG. 9 illustrates a second exemplary user interface for performing mutual authentication in accordance with one or more aspects.

FIG. 10 illustrates a third exemplary user interface for performing mutual authentication in accordance with one or more aspects.

FIG. 11 is a block diagram illustrating an example authentication server for performing mutual authentication in accordance with one aspect.

FIG. 12 illustrates an exemplary method operational in an authentication server for mutually authenticating the user and the authentication server in accordance with one aspect.

FIG. 13 is a block diagram illustrating an example client device for performing mutual authentication in accordance with one aspect.

FIG. 14 illustrates an exemplary method operational in a client device for mutually authenticating the user and the authentication server in accordance with one aspect.

### DETAILED DESCRIPTION

In the following description, specific details are given to provide a thorough understanding of the various aspects. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the disclosed aspects.

The word “exemplary” is used herein to mean “serving as an example, instance, or illustration.” Any implementation or aspect described herein as “exemplary” is not necessarily to be construed as preferred or advantageous over other aspects. Likewise, the term “aspects” does not require that all aspects include the discussed feature, advantage or mode of operation.

### Overview

To combat phishing, companies have employed several anti-phishing methods. The most common method is the display of a user selected graphic during the log process. The user selected graphic method works to a certain extent, but generally fails over time because users would entirely ignore the embedded graphic next to the login interfaces or forget what the graphic looks like. This is probably because of the passive and non-interactive nature of the selected graphic.

The other two commonly used anti-phishing methods are blacklisting and heuristics. The blacklisting approach basically blocks emails and websites that are known to be fraudulent. This approach tends to be weak as scammers routinely change emailing methods and website domain addresses. The heuristic approach looks at available data such as domain registration date and owner of the domain name to determine whether a website might be a phishing website. For example, if the domain registration date is less than 6 months old for an established financial institution, the website is most likely a phishing website. Additionally, if the domain owner cannot be easily ascertain from public records, then the website might be blocked, especially if the website purports to be an established financial institution website. However, this method is inherently weak because it requires the user to sign up with a service that keeps track of all the fraudulent phishing sites. Additionally, due to the false urgency of the phishing emails, unsuspected victims may not perform the due diligence needed to determine the legitimacy of a website.

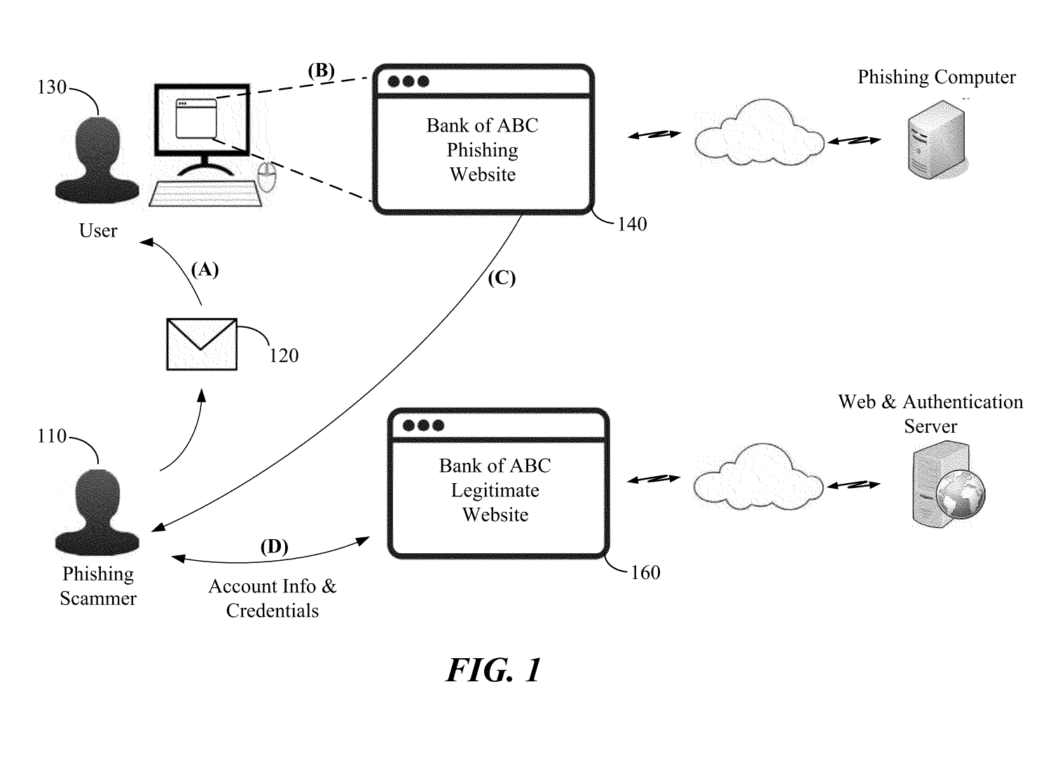

In many cases, it is extremely difficult to distinguish a phishing website from the legitimate one. FIG. 1 illustrates a phishing scheme and why certain approaches fail to prevent it from happening frequently. The phishing scheme starts when a scammer 110 sends an email 120 to a user 130 (at stage A). The email 120 may induce the user 130 to visit a fake phishing website 140 that is designed to look just like a legitimate Bank of ABC website 160. Visually, the websites 140 and 160 are virtually identical. Often times, even their web address are very similar. Even if the legitimate website 160 displays the user selected graphic, the user often overlooks it or ignores it entirely because the use selected graphic is passive and not interactive.

At stage B, the unsuspecting user 130 would then attempt to log into his/her account at the fake phishing website 140, and thereby provides the scammer 110 with the user's account information and credentials (stage C). The scammer 110 then visits the real Bank of ABC website 160 and logs into the user's account using the account information and credentials fraudulently obtained and empties the user's assets (stage D).

Accordingly, in order to enable users to better recognize legitimate websites and distinguish them from fraudulent phishing websites, a first aspect provides for using a plurality of starting symbols associated with the account identifier, wherein the plurality of starting symbols are distinct for different account identifiers and the same plurality of starting symbols is obtained every time the same account identifier is received from the client device.

Additionally, a second aspect provides for using a sensory feedback profile associated with the account identifier, wherein the sensory feedback profile is configured to provide a sensory feedback response upon interaction with each symbol of the plurality of starting symbols.

### Mutual Authentication Using Predetermined Symbols on Secure User Interface

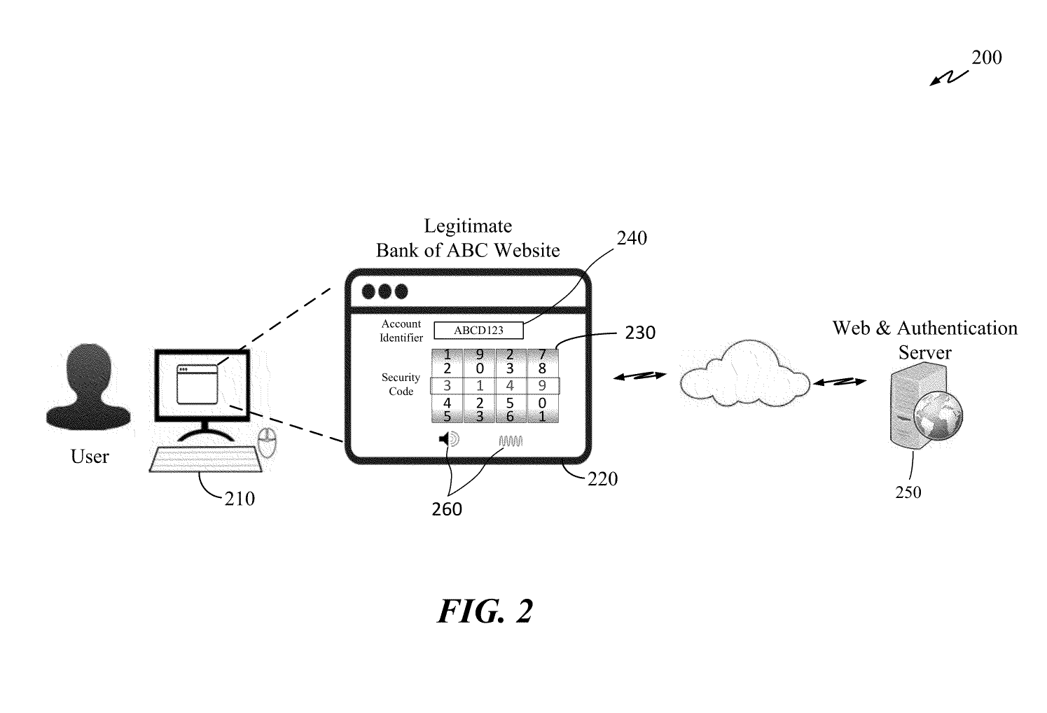

FIG. 2 illustrates an exemplary anti-phishing feature on a website. The exemplary environment 200 may include a client device 210, an application/website interface 220, and a web & authentication server 250. The client device 210 may be a personal computing device, a laptop, a tablet, a mobile phone, a display unit/device, an automatic teller machine (ATM), etc. Using the client device 210, a user may log into the user's bank account which may be stored at a banking or any financial services server. The application interface 220 may be implemented on a web browser or a standalone application such as a mobile phone banking application.

As shown in FIG. 2, the application interface 220 (on the client device 210) may include an interactive user interface 230 that enables the user to input a security code (e.g., user's password or personal identification number (PIN)) to access an account. The application interface 220 may also include an account identifier interface 240 that enables the user to input information identifying the user's account (e.g., a username, account number, etc.). Once the account identifier is entered, the authentication server 250 retrieves a set of starting symbols associated with the account identifier and sends it back to the client device for display on the user interface 230. As shown, the exemplary set of starting symbols has a value of “3149”. In order for the user to input the security code, the user may interact with the user interface 230 and change each symbol of the plurality of starting symbols to enter the correct security code.

In one aspect, the authentication server 250 may also retrieve a sensory feedback profile associated with the received account identifier and sends it to the client device 210. The sensory feedback profile enables the user interface 230 to provide the appropriate feedback response 260 (e.g., sound, tactile) whenever the user interacts with user interface 230. Various examples of an account identifier may include a username, an email address, an account number, or the user's social security number, etc.

The features employed in the exemplary environment 200 are anti-phishing because of the interactive aspects of the user interface 230 and the repeating aspect of the starting symbols and the sensory feedback. After several uses, the user will be accustomed to the position/value of the starting symbols and the sensory feedback provided. Thus, if the user visits a fraudulent phishing website, such as the website 140, those interactive and repeating features will be noticeably absent as only the a web and authentication server 250 has access to the plurality of starting symbols and sensory feedback profile. In this way, the user is able to better recognize that website 140 is fraudulent.

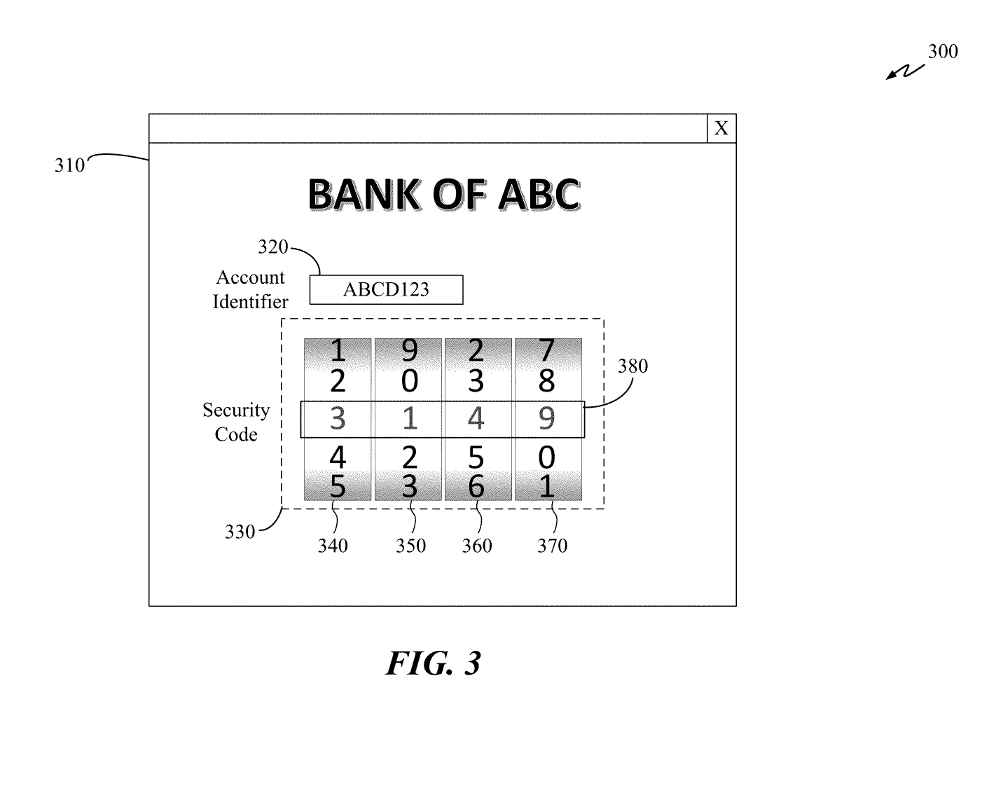

FIG. 3 illustrates an exemplary user interface 300 for providing mutual authentication in accordance to one aspect. The user interface (UI) 300 may be a website 310, an application window, or any suitable form of (UI) running on a client device. A client device may be a computer, a tablet, a mobile phone, etc. As shown, the website 310 includes an account identifier interface 320 and a security user interface 330.

The security user interface 330 may comprise a plurality of interactive portions 340, 350, 360, and 370. In one example, each portion 340, 350, 360, and/or 370 may be an individually set, configured, and/or changed. The security user interface 330 may be a security code interface (e.g., a password interface, a PIN interface, or combination thereof). Each portion 340, 350, 360, and/or 370 may be configured to display a specific symbol from a plurality or set of starting symbols. In one aspect, the set of symbols is a set of integers. Alternatively, the set of symbols may be a set of glyphs, the English alphabet, alphanumeric characters, pictures, foreign languages characters or logogram (e.g., Japanese Kanji), or a combination thereof, etc. Each of the interactive portions 340, 350, 360, and 370 may be interactive and can be changed by the user. The user may change the value of each portion 340, 350, 360, and/or 370 to arrive at the user's security code (e.g., PIN, password, or a combination thereof) by sliding the interactive portion in an upward or downward manner. Alternatively, the user may flick the interactive portion to cause the portion 340, 350, 360, and/or 370 to automatically rotate at a rate of speed corresponding to the speed of the flick. This will scramble the value (e.g., security code) defined in the portions 340, 350, 360, and/or 370 and prevent any malicious software/application on the client device to track the sliding or flicking motion of the user and predict a value displayed on the screen. That is, since the malicious software/application does not know the starting/initial state of the portions 340, 350, 360, and/or 370, it is unable to guess or predict the entered value based on the rotation or change in the portions 340, 350, 360, and/or 370 by the user.

The user interface 300 is an effective anti-phishing tool because it incorporates a similarity/memory element with an interactive element. Once a user visits the financial website 310 of Bank of ABC to log into the user account, both the account identifier interface 320 and the security user interface 330 are empty. Alternatively, the security user interface 330 may be visible but is disabled (grayed out). After the user enters the account identifier, the security user interface 330 may display a set of starting symbols 380 (e.g., as provided by the authentication server/device) to permit the user to enter a code or password to gain access to the account associated with the account identifier. As shown, the exemplary set of starting symbols may be “3149”. The starting symbols may be a randomly generated number or sequence/set of characters/symbols that is associated with the account identifier (e.g., identifying a user account) and/or security code (e.g., password) when the user first activates the user's online account. In one aspect, the same set of starting symbols will be displayed on the interactive security user interface 330 every time the user logs into the user's account, upon entering the correct account identifier.

In one aspect, the correct starting symbols will be displayed only when the correct account identifier is entered and the user is using a client device having an identification information known to the authentication server at Bank of ABC. For instance, a known client device may be a client device with an Internet protocol (IP) and/or media access control (MAC) address that is recognized by the authentication server to be one of the devices previously used by the user to log into the user's account.

The user/client device identification information nay be the IP address of the client device or a combination of the IP and MAC addresses of the client device. If the device is unknown to the authentication server, then new and random starting symbols are displayed. This is to prevent a potential scammer using a second client device from obtaining the user's starting symbols associated with a legitimate first client device. Alternatively, if the authentication server does not recognize the client device, the set of starting symbols is not shown.

Since the same set of starting symbols is shown every time at the login screen for a particular client device) and the user is required to interact with the symbols using the security user interface 330, there is a much higher chance that the user will notice if the symbols are different or not present. In method 300, the starting symbols are not just simply displayed and ignored, but they are part of the interactive feature of the login process. This interactive aspect of the symbols enables the user to better remember the starting position of the symbols of the security user interface 330. In this way, when the user accidentally visit a phishing website, the user will able to recognize that it might be a phishing site because the site is unable to provide the same starting symbols as the user is accustomed to receiving.

Each of interactive interface portions 340, 350, 360, and 370 (e.g., input portions) is independent and separately controllable from each other. In other words, each portion may be independently rotated. Additionally, although the security user interface 330 is shown to have four interactive interface portions, one or more interactive interface portions may be used to increase the password strength.

In one aspect, when the user interacts with each portion of the security user interface 330, a sensory feedback is provided. Each portion may provide a different sensory feedback. In other words, a different sensory feedback whenever the user interacts with a different portion from a plurality of portions of the user interface. The sensory feedback may be a tactile feedback (i.e., vibration), a sound feedback, a visual feedback (e.g., color, pattern), or a combination thereof.

In one aspect, the security user interface 330 is a wheel that is configured to rotate as the user interacts with the security user interface 330. For example, the user may cause a first portion 340 to rotate in the upward direction by moving the first portion 340 upward. The first portion 340 may rotate and cycle through all of the values displayed on the first portion 340. Once a full rotation is completed, the value starts again from the beginning.

In one aspect, the starting symbol of each interface portion is selected such that it is at least two positions away from security code. For example, if the security code is “4350”, then the first portion 340 (e.g., “4”) has to be greater than 5 or less than 3, a second portion 350 (e.g., “3”) has to be greater than 4 or less than 2, a third portion 360 (e.g., “5”) has to be greater than 6 and less than 4, and a fourth portion 370 (e.g., “0”) has to be greater than 1 and less than 9 (i.e., where the numbers roll over from “0” to “9”).

In one aspect, each of the starting symbols are selected such that they are not identical to the symbol/number in the corresponding position of the security code. For example, if the security code is “4350”, then the symbol in the first position cannot be equal to 4, the symbol in the second position cannot be equal to 3, the symbol in the third position cannot be equal to 5, and the symbol in the fourth position cannot be equal to 0.

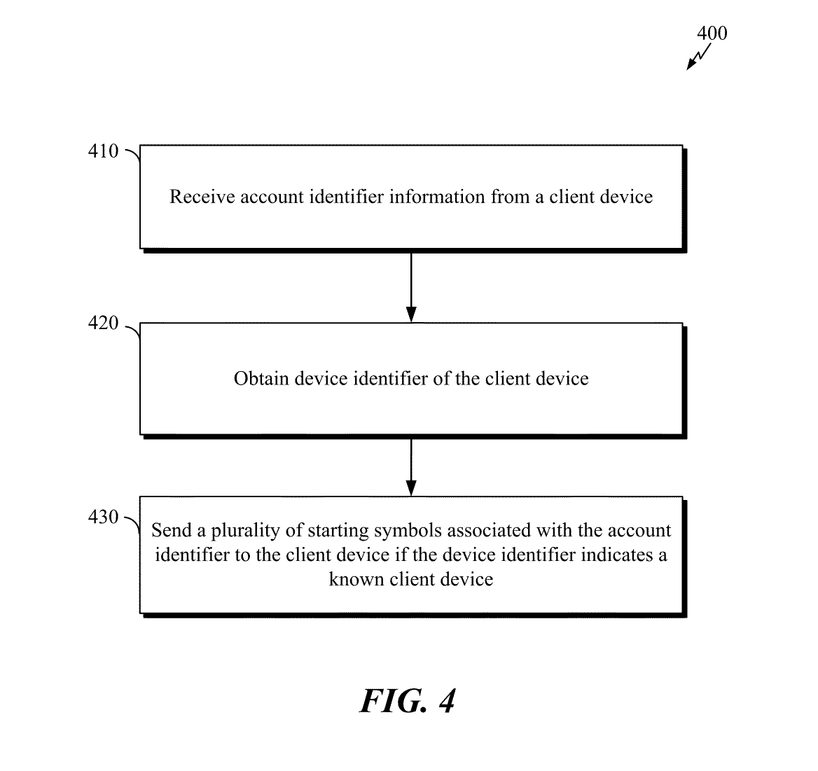

FIG. 4 illustrates an exemplary process 400 for mutual authentication in accordance with one aspect. The account identifier may be received from a client device 410. A device identifier of the client device may also be obtained 420. For example, the device identifier may be the device IP address, a MAC address, or both. A plurality of starting symbols associated with the account identifier (e.g., username or the user's account) may be sent to the client device for display on a user interface if the device identifier indicates that the client device is a known device 430. Thus, if a scammer attempts to steal the user's identity and uses the user login credentials to log into the user's account, the additional security layer of checking for known device would prevent the would be scammer from obtaining the starting symbols associated with the user's account.

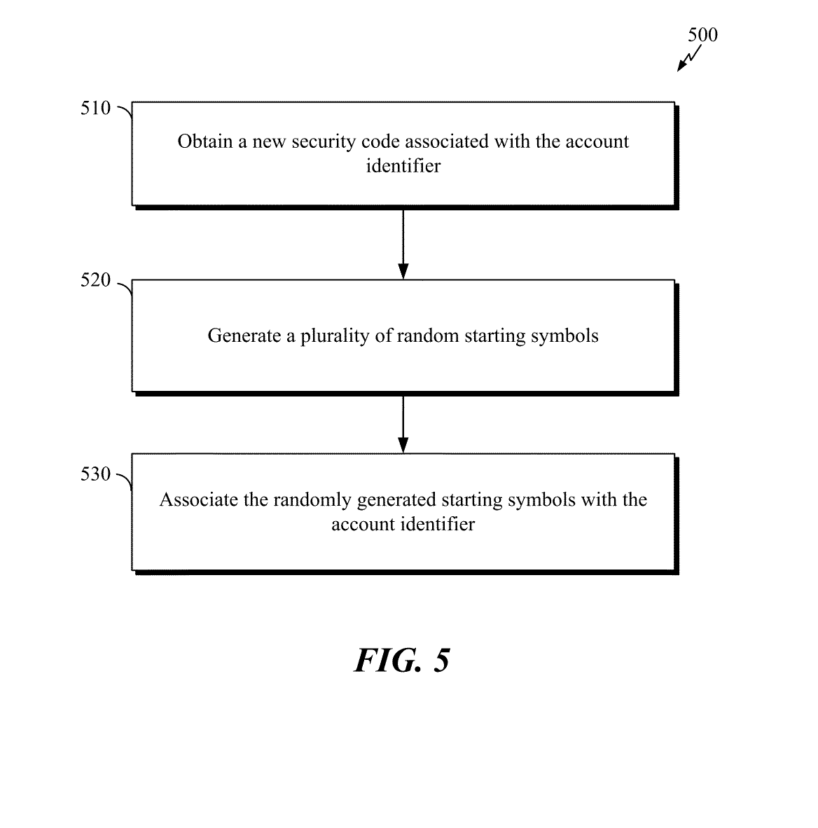

FIG. 5 illustrates an exemplary process 500 for randomly generating symbols in accordance to one aspect. A security code (e.g., password) associated with the account identifier may be obtained/received 510. This step may take place during the account registration process or whenever the user wishes to change the security code (e.g., password). A plurality of random starting symbols or random new starting symbols may be generated, obtained, or received 520. For example, in FIG. 3, the plurality of starting symbols are “3149”. In one aspect, the user may elect to use a previously generated starting symbols to be associated with the new security code. Alternatively, the authentication server/device may allow the user to select a security code and the plurality of starting symbols as long as they are different from each other. The randomly generated or user selected starting symbols may be associated with the account identifier (e.g., user's password and/or account number) 530. In one aspect, the starting symbols are associated with the account identifier. In this way, the client device may display the correct starting symbols to the user after the user has entered the appropriate account identifier. Alternatively, the plurality of starting symbols may be automatically displayed on the client device upon the identification of a device identifier (e.g., a known device or IP address previously associated with the account identifier at the authentication device/server).

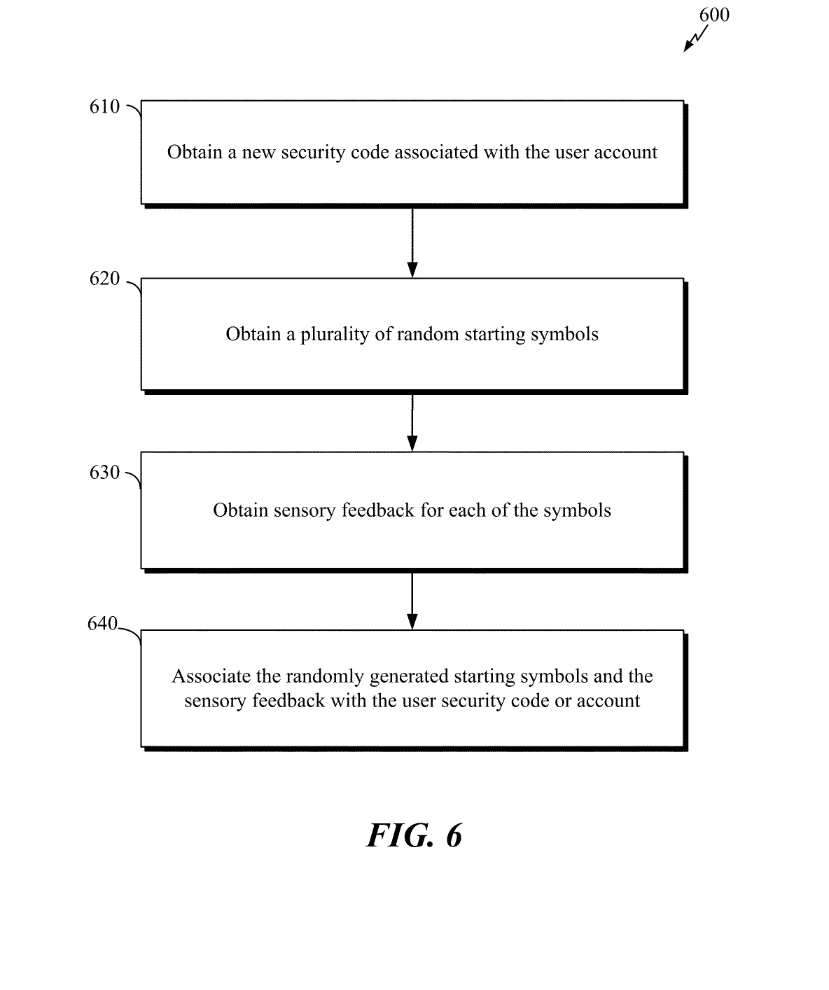

FIG. 6 illustrates an exemplary process 600 for generating sensory feedback and starting symbols in accordance to one aspect. In addition to providing a plurality of starting symbols to help the user recognize a potential phishing website when the plurality of starting symbols are not displayed during the login process, a sensory feedback is provided each time the user interacts with the security user interface. As previously described, the security user interface 330 (FIG. 3) may comprise several portions, one portion for each symbol to be selected for a security code. Each of the portion may provide a different sensory feedback to the user whenever the user interacts with it. A new password is obtained from the user 610. A plurality of random starting symbols are obtained 620 (e.g., generated, selected, etc.). Sensory feedback for each of the symbols may also be obtained 630 (e.g., generated, selected, etc.). Each symbol may have the same sensory feedback or a different sensory feedback. Both the starting symbols and the sensory feedback profile of the plurality of symbols may be associated with the user password or account 640.

Referring now to FIG. 3, the security user interface 330 may have a distinct sensory feedback profile to help the user become familiarize with the look and feel of legitimate website. In one aspect, the sensory feedback profile for the security user interface 330 is purely tactile. In other words, each of the input portions 340, 350, 360, and 370 is configured to provide a tactile feedback when the user interacts with it. Each portion may have the same or different tactile feedback response. For example, the first portion 340 may be configured to vibrate once when the user interacts with it. The second portion 350 may be configured to vibrate twice, and the third and fourth portions 360 and 370 may both be configured to vibrate once very briefly. In one aspect, the sensory feedback profile of user interface input portions 340, 350, 360, and 370 may be a tactile, sound, visual effect (e.g., color, pattern), or a combination thereof.

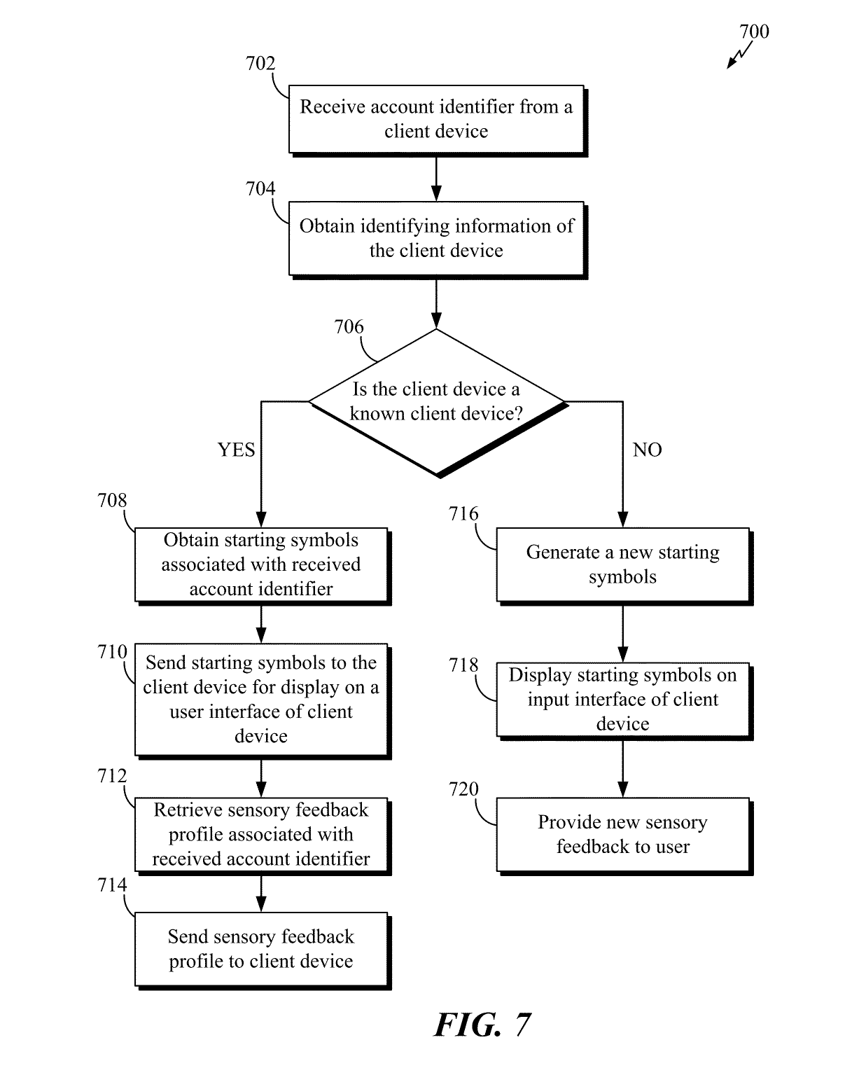

FIG. 7 illustrates an exemplary process 700 for providing mutual authentication in accordance to one aspect. An account identifier (e.g., username, account number, etc.) may be received from a client device at an authentication server/device (e.g., a remote server) 702. The account identifier may be provided using the account identifier interface 320 (FIG. 3), for example. The device identifier of the client device may be obtained by the authentication module 704. The authentication module determines whether the client device is a known client device 706. This may be done by analyzing the MAC address of the client device. Additionally, the authentication module may also look at the IP address associated with the client device to determine whether the user is on his/her regular home network.

If the client device is a known client device, the plurality of starting symbols associated with the received account identifier are retrieved 708. For example, the plurality of starting symbols of the security user interface 330 (FIG. 3) are “3149”. The starting symbols may be integers, alphanumeric characters, glyphs, pictures, foreign language characters, or a combination thereof. For example, the starting symbols may be “A5C9”.

The plurality of starting symbols are generated randomly during the initial account and password/password registration or during the password changing process. In one aspect, the starting symbols may be user selected. Whether the starting symbols are randomly generated or selected by the user, the starting symbols must be different than the password.

The retrieved/obtained starting symbols may be sent to the client device for display on the user interface of the client device 710. Each starting symbol is associated with a user interface portion that is interactive. In one aspect, the user interface is a rotatable wheel as shown in FIG. 3. The sensory feedback profile associated with the account identifier (e.g., username or user account) for the plurality of symbols may be retrieved 712. The sensory feedback profile is then provided to the client device 714. This enables the client device to provide sensory feedback based on the feedback profile to the user each time the user interacts with one of the user interface portions. For example, the sensory feedback profile for the user interfaces may include vibrations and sounds. For instance, for the four interactive portions 340, 350, 360, and 370 (FIG. 3) may have a vibration, sound, sound, and vibration feedback, respectively each portion has either a vibration and/or sound). In this way, after several log in procedures, the user will be familiarized by the starting symbols and the sensory feedback (e.g., a combination of symbols and vibration/sounds for each interactive portion). Thus, when the user interacts with a fraudulent phishing website without the expected starting symbols and sensory feedback, the user will likely suspect that site might be fraudulent.

Referring back to step 706, if the client device is not known, a new set of starting symbols is generated 716 and displayed 718 to the user on security user interface 330 (FIG. 3). The authentication module may also provide a random sensory feedback profile for the interactive portions 340, 350, 360, and 370 of the user interfaces 720.

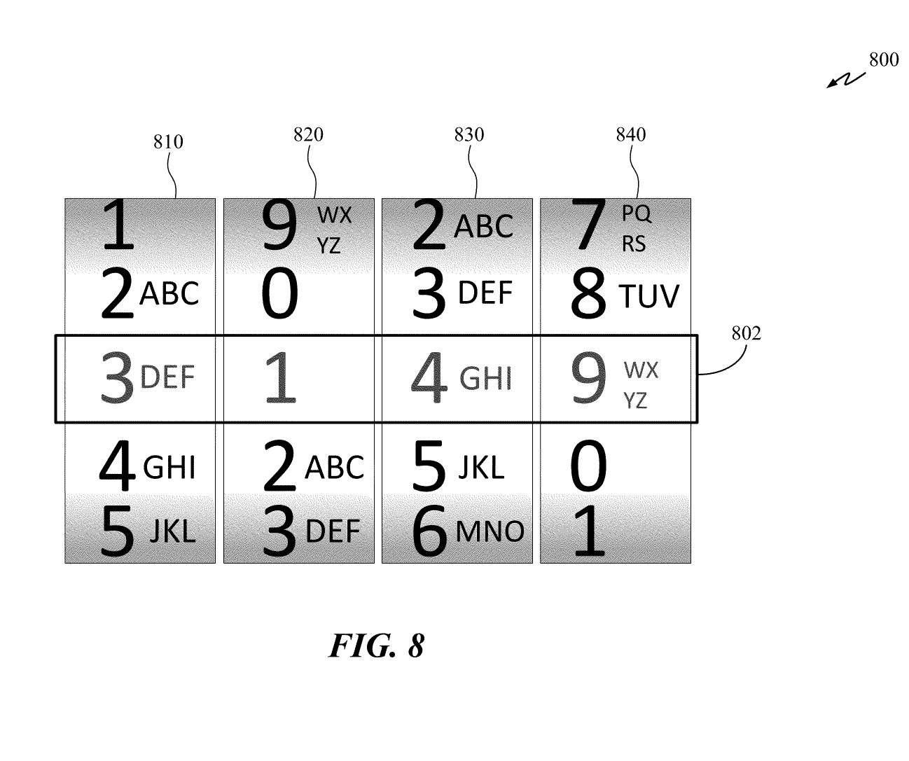

FIG. 8 illustrates an exemplary user interface 800 in accordance with one aspect. The user interface 800 may include one or more interactive interface portions 810, 820, 830, and 840. In one aspect, each of the interactive interface portions 810, 820, 830, and 840 may display a combination of alphanumeric characters (e.g., glyphs, symbols, etc.). Alternatively, each of the interactive interface portions 810, 820, 830, and 840 may display only alphabet characters. Each of the interactive interface portions 810, 820, 830, and 840 may be rotated (e.g., up or down) until a desired character (e.g., glyph, symbol, or number) is displayed at a selection region 802. The characters in each interactive interface portions 810, 820, 830, and 840 may cycle through and start at the beginning once the interactive interface portion 810, 820, 830, and 840 completely rotates through an entire set of characters. For example, each interactive interface portion 810, 820, 830, and 840 may be a wheel-like interface having integer values from 0-9 and/or alphabet characters A-Z. When the user interacts with each of the interactive interface portions 810, 820, 830, and 840, these rotate in the upward or downward direction cycling through the set of characters and restarting once a full revolution is completed. It should be noted that the processes 400, 500, 600 and 700 may employ a user interface similar or identical to the user interface 800. Additionally, although the user interface 800 is shown to have four interactive interface portions 810, 820, 830, and 840, greater or fewer interactive input interface portions may be used to have a longer or shorter password length.

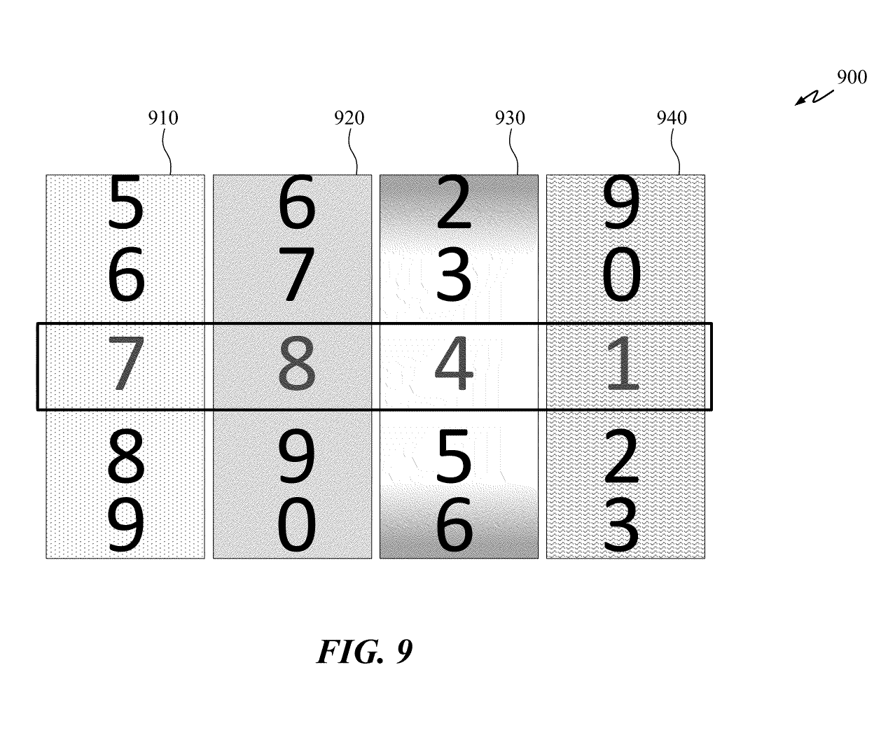

FIG. 9 illustrates an exemplary user interface 900 in accordance with one aspect. The user interface 900 may include a plurality of interactive interface portions 910, 920, 930, and 940. Each of the interactive interface portions 910, 920, 930, and 940 may have a predetermined visual feedback mode that is part of the sensory feedback profile for the user interface 900. In one aspect, the sensory feedback profile for the user interface 900 is automatically selected by the authentication server. Alternatively, the authentication server may allow the user to design, create, generate, select, and/or obtain a sensory feedback profile during the initial account registration or when the user desires to create a new password. In one aspect, the sensory feedback profile may be changed by the user at any time.

As shown in FIG. 9, the interactive interface portions 910, 920, 930, and 940 may have a visual feedback mode. When the user interacts with the interactive interface portion 910, 920, 930, or 940, it interactively responds by changing its pattern (e.g., color, shading, and/or pattern for the portion), in one example, a first interactive interface portion 910 may have first hashing pattern, a second interactive interface portion 920 may have a solid color, a third interactive interface portion 930 may have a shaded pattern/color, and a fourth interactive interface portion 940 may have a second hashing pattern. These patterns may be present when the user interface 900 is initially presented to the user, or they may be displayed when the user interacts with one or each of the interactive interface portions 910, 920, 930, and 940 (e.g., the portion changes from a default to the pattern indicated by the visual feedback mode when a portion is touched by the user).

In one aspect, the sensory feedback profile may be associated with the account identifier (e.g., username or account number) and the same sensory feedback profile is used every time the same user interacts with the user interface 900. In this way, the user may gain familiarity with the user interface 900 and would expect the same sensory feedback each time the user visits the Bank of ABC's website. Thus, when the user accidentally visits a phishing website, without the sensory feedback or with an incorrect sensory feedback profile, the user may discover the attempted scam of the fraudulent website. It should be noted that the described processes 400, 500, 600 and 700 may employ a user interface similar or identical to the user interface 900. Additionally, the user interface 900 may have a plurality of interactive interface portions. For example, to increase the password strength, five or more interactive interface portions may be used.

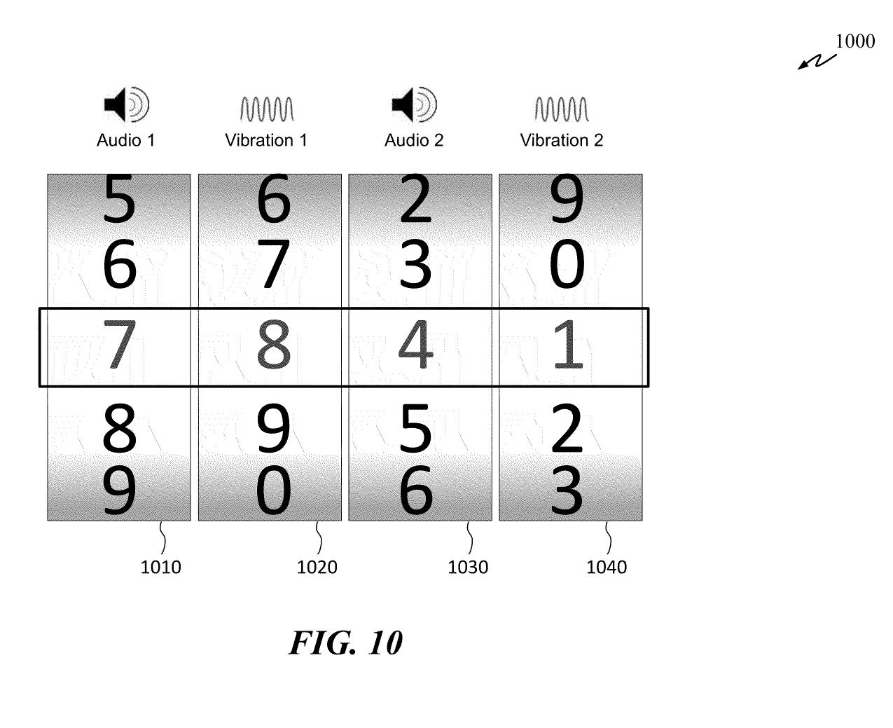

FIG. 10 illustrates another exemplary user interface 1000 in accordance with yet another aspect. The user interface 1000 may include a plurality of interactive interface portions 1010, 1020, 1030, and 1040 (e.g., input portions). A sensory feedback profile of the user interface 1000 may also include audio feedback, tactile feedback, and/or a combination of audio and tactile feedback. As shown in FIG. 10, the feedback mode for a first interactive interface portion 1010 is a first audio or sound. Thus, when a user interacts with first interactive interface portion 1010, an audio is played. The audio could be a beep, a series of tones, a short melody, or even a song. The feedback mode for a second interactive interface portion 1020 may be a first tactile response. The first tactile response may be a single vibration such as a short pulse, medium pulse, or a long pulse. The first tactile response may include one or more vibrations. Similarly, the feedback mode for a third interactive interface portion 1030 may be a second audio response. Likewise, the feedback mode for a fourth interactive interface portion 1040 may be a second tactile response. It should be noted that each of the interactive interface portions 1010, 1020, 1030, and 1040 of user interface 1000 can be either tactile, audio, visual or a combination thereof. Additionally, it should be noted that the described processes 400, 500, 600, and 700 may employ a user interface similar or identical to the user interface 1000.

### Exemplary Authentication Device and Method Operational Therein

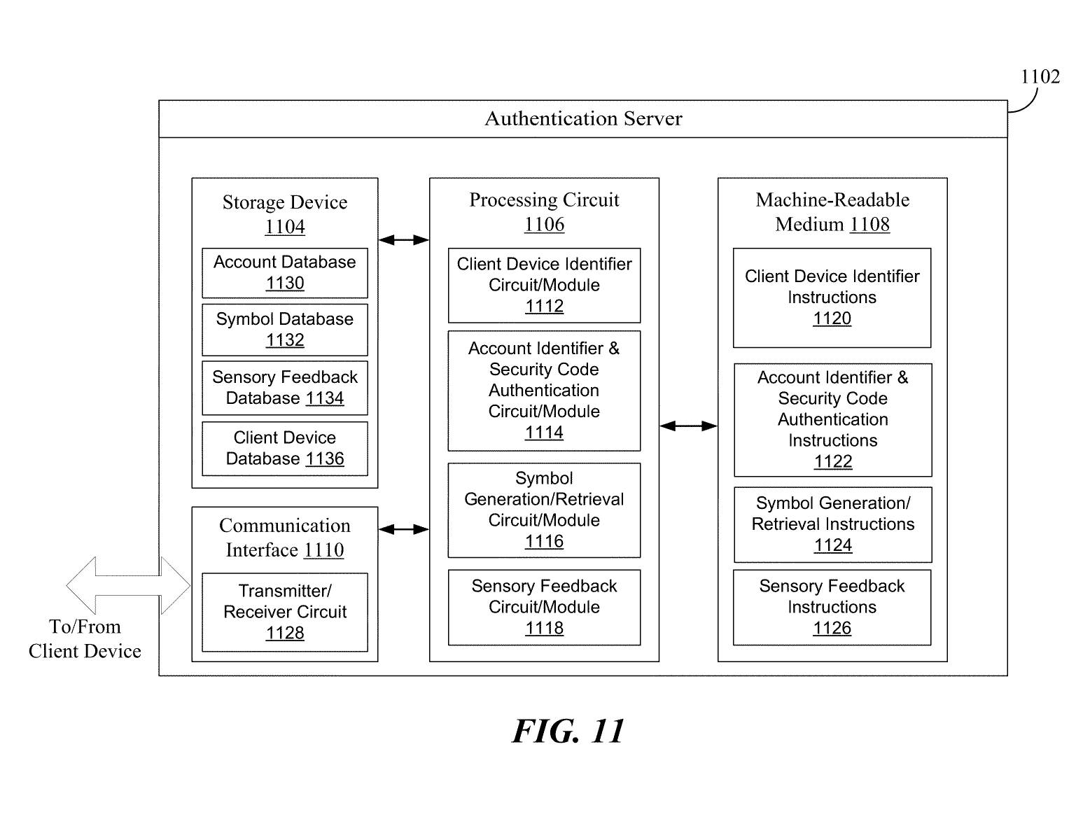

FIG. 11 is a block diagram illustrating an exemplary authentication server/device 1102 adapted to provide mutual authentication by authenticating an account identifier by providing a plurality of starting symbols and/or sensory feedback based on the account identifier. The authentication server/device 1102 may include a storage device 1104, a processing circuit 1106, a machine-readable medium 1108, and/or a communication interface 1110.

The storage device 1104 may be adapted to store one or more of account data (e.g., account identifiers using an account database 1130), user credentials (e.g., security code using the account database 1130), starting symbols associated with each account identifier (e.g., using a symbol database 1132), and/or sensory feedback profiles (e.g., using a sensory feedback database 1134), client device identifying information (e.g., such as a device identifier based on an Internet protocol (IP) address and media access control (MAC) address (e.g., using a client device database 1136), etc.

The processing circuit 1106 may include a client device identifier circuit/module 1112, an account identifier & security code authentication circuit/module 1114, a symbol generation/retrieval circuit/module 1116, and a sensory feedback circuit/module 1118. The client device identifier circuit/module 1112 may be adapted to determine whether a client device is a known device (e.g., previously associated with a provided account identifier). For example, the client device identifier may be based on an IP address or MAC address of the client device and it is associated with an account identifier the first time a user successfully authenticates the account identifier using a correct security code. Note that multiple device identifiers may be associated with a particular account identifier.

The account identifier and security code authentication circuit/module 1114 may be adapted to authenticate the user login information, such as the account identifier and/or security code. For example, once the account identifier and security code authentication circuit/module, 1114 authenticates a correct account identifier, it may authorize the symbol generation/retrieval circuit/module 1116 and/or the sensory feedback circuit/module 1118 to provide or send one or more starting symbols and a sensory profile to the client device via communication interface 1110.

The symbol generation/retrieval circuit/module 1116 may be responsible for generating, obtaining, and/or associating starting symbols with each user account (e.g., account identifier). The symbol generation/retrieval circuit/module 1116 may also generate new starting symbols whenever the client device (e.g., based on a device identifier) is unknown to the authentication server. The symbol generation/retrieval circuit/module 1116 may also generate one or more new symbols every time the security code (e.g., password) is changed. The newly generated symbols are then associated with the account identifier (e.g., a username, account number, etc.), and/or the security code (e.g., private identification number, an alphanumeric password, etc.). In this way, when the user seeks to log into the account the new starting symbols can be displayed.

The symbol generation/retrieval circuit/module 1116 may be configured to generate starting symbols for the user interfaces 300, 800, 900, and 1000 and/or retrieve pre-stored symbols. The symbol generation/retrieval circuit/module 1116 may also be adapted to perform one or more steps or functions illustrated in FIGS. 3-10.

The sensory feedback circuit/module 1118 may be configured to generate one or more sensory feedback profiles for each of the user account. The sensory feedback profile dictates the type of sensory response the user would receive when the user interacts with the user interface such as one of the user interfaces 300, 800, 900 and 1000. The sensory feedback circuit/module 1118 may also generate a sensory feedback for each of the interactive interface portions (e.g., showing the starting symbols) (e.g., interactive interface portions 1010, 1020, 1030, and 1040). The sensory feedback circuit/module 1118 may operate in conjunction with storage device 1104 to generate and/or store one or more sensory feedback profiles for each user account. The sensory feedback circuit/module 1118 may be adapted to perform one or more steps or functions illustrated in FIGS. 6, 7, 9, and 10.

The machine-readable medium 1108 may include client device identifier instructions 1120, account identifier and security code authentication instructions 1122, symbol generation/retrieval instructions 124, and/or sensory feedback instructions 1126. The client device identifier instructions 1120 may include code and/or instructions that cause the processing circuit 1106 to perform one or more steps or functions in FIGS. 4, 6, and/or 7. The client device identifier instructions 1120 may include code/instructions that enables the processing circuit 1106 to determine whether a client device is a known device using IP and/or MAC address of the client device.

The account identifier and security code authentication instructions 1122 may include instructions that cause the processing circuit 1106 to authenticate the account identifier (e.g., username o user account) and security code (e.g., password).

The symbol generation/retrieval instructions 1124 may include instructions that cause the processing circuit 1106 to generate and/or associate starting symbols with each account identifier (e.g., user account). The symbol generation/retrieval instructions 1124 may also generate new starting symbols whenever the client device is unknown to the authentication server 1102 or when the user changes the security code for the account. The newly generated symbols are then associated with the account identifier and/or the security code.

The symbol generation/retrieval instructions 1124 may be adapted to generate starting symbols of the user interfaces 300, 800, 900, and 1000. The symbol generation/retrieval instructions 1124 may also be adapted to perform one or more steps or functions illustrated in FIGS. 3-10.

Additionally, the communication interface 1110 may include a transmitter/receiver circuit 1128 that enables the authentication server 1102 to communicate (e.g., wired or wirelessly) with one or more client devices.

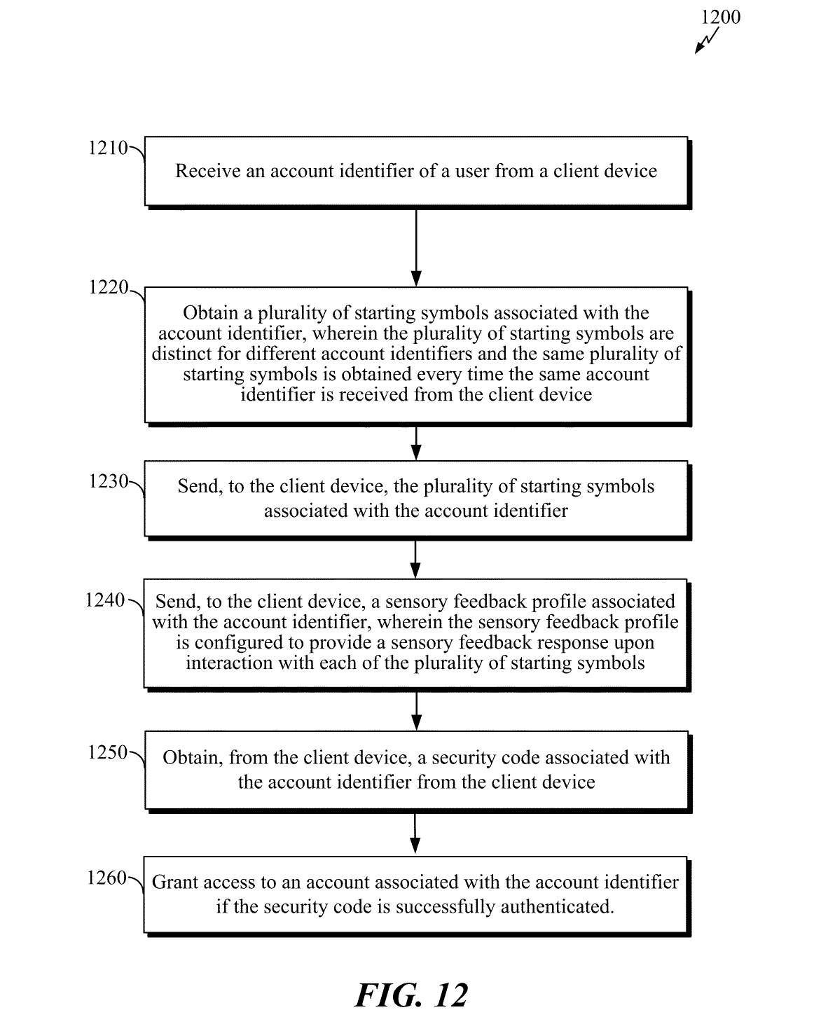

FIG. 12 illustrates a process 1200 operational at an authentication server for mutually authenticating the client device and the authentication server (banking server) to the user. The authentication server may receive an account identifier of a user from the client device 1210. The account identifier may include a user identifier, username, account number, etc.

A plurality of starting symbols associated with the account identifier may also be obtained, wherein the plurality of starting symbols are distinct for different account identifiers and the same plurality of starting symbols is obtained every time the same account identifier is received from the client device 1220. Each symbol of the plurality of symbols may be at least one of an alphanumeric character, a pattern, a picture, a glyph, and a color.

In one aspect, the authentication server may also receive a device identifier from the client device. In one example, the plurality of starting symbols associated with the received account identifier is only obtained if the device identifier was previously associated with the account identifier. The authentication server may send (via a communication interface) the plurality of retrieved starting symbols associated with the account identifier to the client device 1230. Otherwise, a plurality of new starting symbols is generated and sent if the device identifier indicates that the client device was previously unassociated with the account identifier.

Subsequently, a security code associated with the account identifier may be obtained from the client device 1250. Authentication of the security code permits the authentication server to verify whether the user should gain access the account associated with the account identifier. The authentication server may thus grant access to an account associated with the account identifier if the security code is successfully authenticated 1260. The security code may be successfully authenticated if it matches a security code previously associated with the account identifier.

In one example, where starting symbols have not been previously associated with the account identifier and/or the security code, the authentication server may obtain a security code associated with the account identifier. Then it may randomly generate the plurality of starting symbols while guaranteeing that the plurality of starting symbols is distinct from the security code. That is, the starting symbols may be generated in a random manner to guarantee that they are distinct from the security code. The plurality of starting symbols may be associated with the account identifier. In one implementation, each symbol of the plurality of starting symbols may be distinct from each corresponding symbol of the security code. In some instances, each symbol of the plurality of starting symbols may be selected from a set of ordered symbols, each symbol of the plurality of starting symbols is at least two symbols away in the set of ordered symbols from a corresponding symbol of the security code.

According to one aspect, a sensory feedback profile associated with the account identifier may be sent to the client device, wherein the sensory feedback profile is configured to provide a sensory feedback response upon interaction with each symbol of the plurality of starting symbols 1240.

The sensory feedback profile may be generated at the authentication server (e.g., at a setup time or the first time a user attempts to log onto an account). The sensory feedback profile is associated with the account identifier, wherein the same sensory feedback profile is sent each time the account identifier is received by the authentication server. In one example, the same sensor feedback profile is used every time the device identifier indicates that the client device was previously associated with the account identifier. In on example, each symbol of the plurality of starting symbols may be associated with interactive interface portion of a user input interface, and a different sensory feedback response is associated with each interactive interface portion. In various examples, the sensory feedback response may be one of a tactile response, a visual response, an audio response, or a combination of a tactile, a visual, or an audio response.

Note that, according to one aspect, neither the plurality of starting symbols nor the sensory feedback profile are permanently stored in the client device. Instead, the plurality of starting symbols and/or the sensory feedback profile is provided by the authentication server upon sending the account identifier from the client device. Thus, any attacker or impersonator is not able to provide the correct plurality of starting symbols and/or the sensory feedback profile to the client device, thereby alerting the user of a potential risk.

In various implementations, authentication server/device 1102 may operate as illustrated and described with reference to FIGS. 2-10.

### Exemplary Client Device and Method Operational Therein

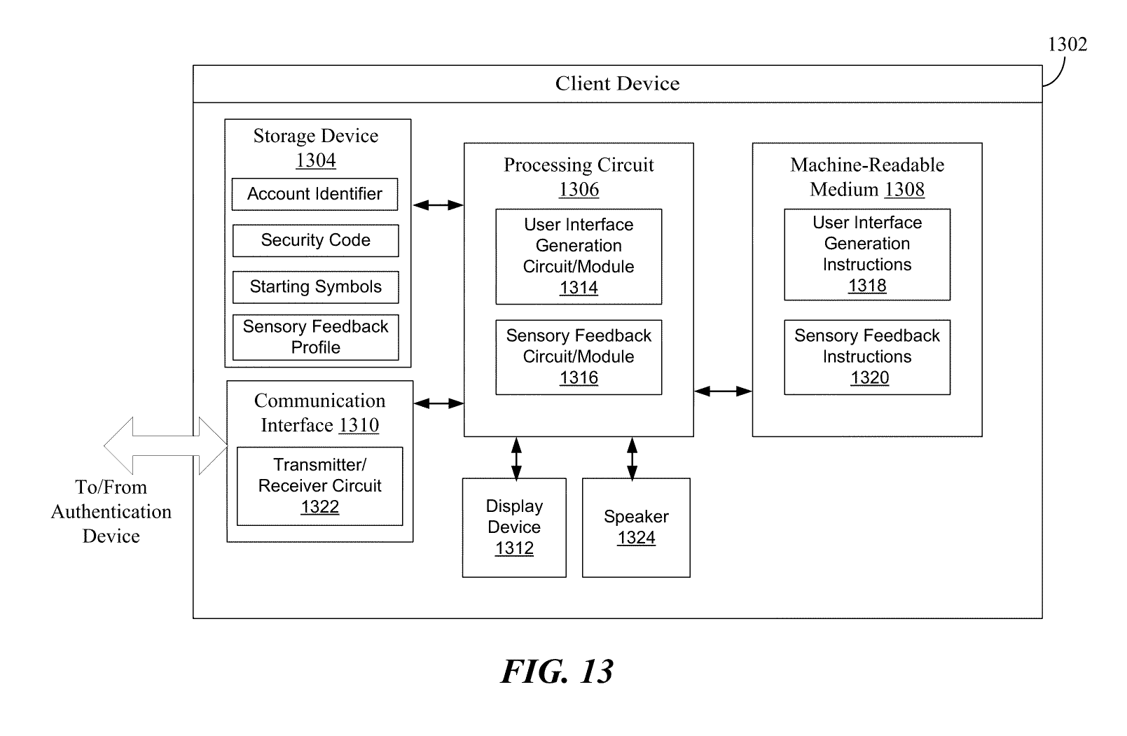

FIG. 13 is a block diagram illustrating an exemplary client device 1302 configured to provide an account identifier, device identifier, and/or security code to the authentication server. The client device 1302 may include a storage device 1304, a processing circuit 1306, a machine-readable medium 1308, a communication interface 1310, a display device 1312, and/or a speaker 1324. The storage device 1304 may be adapted to temporarily store at least one of the account identifier, security code, a plurality of starting symbols, and/or a sensory feedback profile.

The processing circuit 1306 may include a user interface generation circuit/module 1314 and a sensory feedback circuit/module 1316. The user interface generation circuit/module 1314 may be adapted to generate a user interface and starting symbols (e.g., received from the authentication server) to be sent to the display device 1312. The user interface generation circuit/module 1314 may also be adapted to generate other features on the display device 1312 such as visual effects based on inputs from sensory feedback circuit/module 1316.

The user interface generation circuit/module 1314 may also be adapted to generate and/or send the user interface (e.g., user interface 230, 300, 800, 900, and/or 1000) to the display device 1312.

The sensory feedback circuit/module 1316 may be configured to provide one or more sensory feedback responses based on a sensory feedback profile received/obtained from an authentication server 1102 (FIG. 11). The sensory feedback response may be tactile, sound, visual effects, or a combination thereof. If the sensory feedback response is visual, the feedback will be displayed on the display device 1312. If the feedback is audio, the audio or sound will be transmitted by the speaker 1324. Additionally, the sensory feedback circuit/module 1316 may be adapted to provide a sensory feedback response as described in at least FIGS. 9 and 10.

The communication interface 1310 may include a transmitter/receiver circuit 1322 that enables the client device 1302 to communicate (e.g., wired or wirelessly) with the authentication/web server 1102.

In one example, the processing circuit 1306 may be configured to send an account identifier of a user to the authentication server. In response, the processing circuit may receive (via the communication interface 1310) a plurality of starting symbols associated with the account identifier, wherein the plurality of starting symbols are distinct for different account identifiers and the received plurality of starting symbols are the same every time the account identifier is sent from the client device. The processing circuit 1306 may then display, on the display device 1312, the plurality of starting symbols within an interactive input interface to allow the user to select a security code.

The machine-readable medium 1308 may include user interface generation instructions 1318 and sensory feedback instructions 1320. The user interface generation instructions 1318 may include instructions that cause the processing circuit 1306 to generate various interactive user interfaces. The user generation instructions 1318 also may include instructions to cause the processing circuit 1306 to display starting symbols on display device 1312. The user interface generation instructions 1318 may include instructions to cause the processing circuit to generate other features on the display device 1312 such as visual effects based on inputs from sensory feedback instructions 1320.

The sensory feedback instructions 1320 may include instructions to cause the processing circuit 1306 to provide a sensory feedback response based on the sensory feedback profile received from the authentication server 1102 (FIG. 11). If the feedback response is visual, the feedback instructions 1320 will cause the processing circuit 1306 to display the visual effect on the display device 1312. If the feedback is audio, feedback instructions 1320 will cause the processing circuit 1306 to play the audio on the speaker 1324. Additionally, the sensory feedback instructions 1316 may include instructions to cause the processing circuit 1306 to provide a sensory feedback response as described in at least FIGS. 9 and 10.

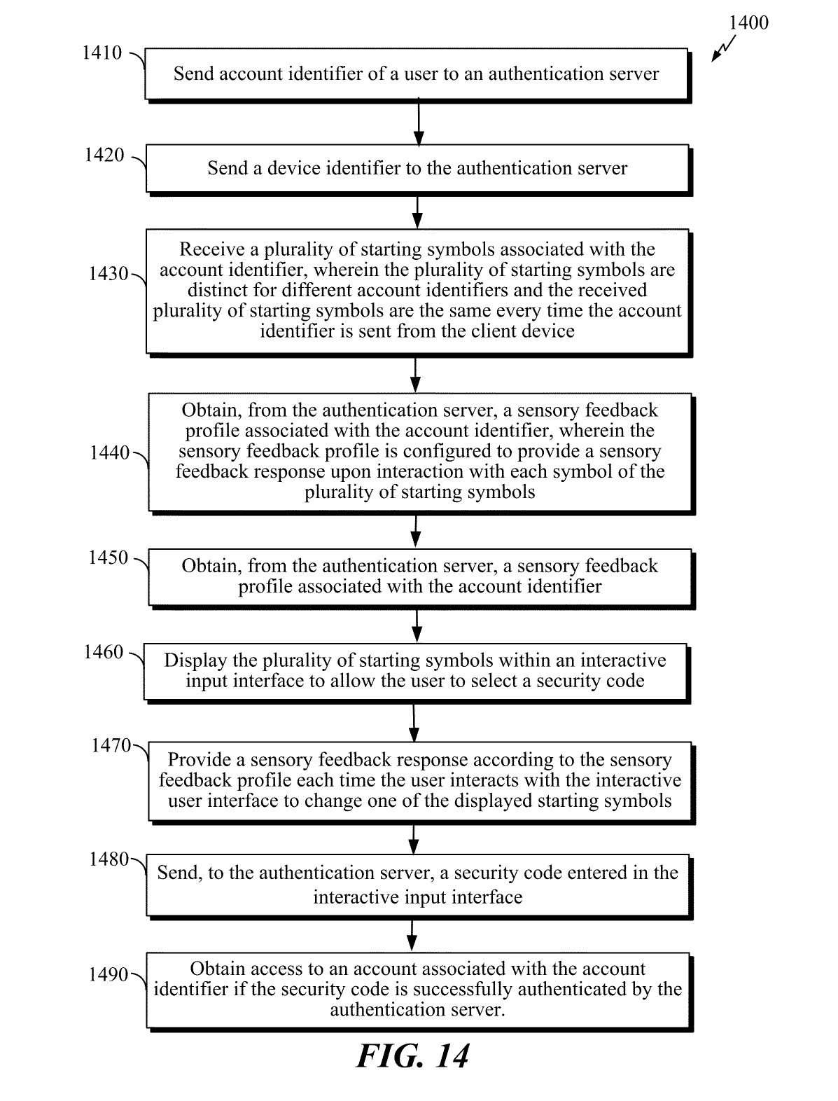

FIG. 14 illustrates a process 1400 operational at a client device for mutually authenticating the client device and the authentication server (e.g., banking server) to a user. An account identifier (e.g., username, account number, etc.) of the user is sent from a client device to an authentication server (e.g., bank or financial services server) 1410. A device identifier (e.g., IP address, etc.) may also be sent to the authentication server 1420. A plurality of starting symbols associated with the account identifier (and/or the device identifier) may be received in response to the account identifier being sent to the authentication server, wherein the plurality of starting symbols are distinct for different account identifiers and the received plurality of starting symbols are the same every time the account identifier is sent from the client device 1430. In one example, each symbol of the plurality of starting symbols is associated with a different interactive interface portion of a user input interface, and a different sensory feedback response is associated with each interactive interface portion. A sensory feedback profile associated with the account identifier may also be obtained from the authentication server, wherein the sensory feedback profile is configured to provide a sensory feedback response upon interaction with each symbol of the plurality of starting symbols 1440. A sensory feedback profile associated with the account identifier is received from the authentication server 1450. In one example, the same sensory feedback profile is received by the client device every time a same device identifier and account identifier are sent to the authentication server. The plurality of starting symbols associated with the account identifier are displayed within an interactive input interface to allow the user to select a security code 1460. A sensory feedback response is provided according to the sensory feedback profile each time the user interacts with the interactive user interface to change one of the displayed starting symbols 1470. A security code entered in the interactive input interface may be obtained and/or sent to the authentication server 1480. In one example, the interactive input interface is a rotating interface configured to individually change each symbol of the plurality of starting symbols upon interaction by a user. If the security code is successfully authenticated by the authentication server, the client device obtains/gains access to an account associated with the account identifier 1490.

In one aspect, the plurality of starting symbols are only received if the client device is known to the authentication based on the device information.

One or more of the components, steps, features, and/or functions illustrated in FIGS. 1-14 may be rearranged and/or combined into a single component, step, feature or function or embodied in several components, steps, or functions. Additional elements, components, steps, and/or functions may also be added without departing from the invention. The apparatus, devices, and/or components illustrated in FIGS. 1-2, 3, 8-11, and 13 may be configured to perform one or more of the methods, features, or steps described in FIGS. 4-7, 12, and 14. The algorithms described herein may also be efficiently implemented in software and/or embedded in hardware.

Moreover, in one aspect of the disclosure, the processing circuit 1106 and 1306 illustrated in FIGS. 11 and 13 may be specialized processors (e.g., an application specific integrated circuit (e.g., ASIC)) that are specifically designed and/or hard-wired to perform the algorithms, methods, and/or steps described in FIGS. 4-7 respectively. Thus, such a specialized processor (e.g., ASIC) may be one example of a means for executing the algorithms, methods, and/or steps described in FIGS. 4-7, 12, and 14.

Also, it is noted that the aspects of the present disclosure may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, aspects of the disclosure may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing circuit, programming instructions, or other directions, and may be included in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A method operational at an authentication server, comprising:
receiving an account identifier of a user from a client device;
obtaining a plurality of starting symbols associated with the account identifier, wherein the plurality of starting symbols are distinct for different account identifiers and the same plurality of starting symbols is obtained every time the same account identifier is received from the client device; and
sending, to the client device, the plurality of starting symbols associated with the account identifier.

2. The method of claim 1, wherein each symbol of the plurality of symbols is at least one of an alphanumeric character, a pattern, a picture, a glyph, and a color.

3. The method of claim 1, wherein the account identifier includes at least one of a user identifier, username, and account number.

4. The method of claim 1, further comprising:
receiving a device identifier from the client device, wherein the plurality of starting symbols associated with the account identifier is only obtained if the device identifier was previously associated with the account identifier.

5. The method of claim 4, further comprising:
sending, to the client device, a plurality of new starting symbols if the device identifier indicates that the client device was previously unassociated with the account identifier.

6. The method of claim 4, wherein the same plurality of starting symbols is obtained only if the device identifier indicates that the client device was previously associated with the account identifier.

7. The method of claim 1, further comprising:
obtaining, from the client device, a security code associated with the account identifier;
randomly generating the plurality of starting symbols while guaranteeing that the plurality of starting symbols is distinct from the security code; and
associating the plurality of starting symbols with the account identifier.

8. The method of claim 7, wherein each symbol of the plurality of starting symbols is distinct from each corresponding symbol of the security code.

9. The method of claim 7, wherein each symbol of the plurality of starting symbols is selected from a set of ordered symbols, each symbol of the plurality of starting symbols is at least two symbols away in the set of ordered symbols from a corresponding symbol of the security code.

10. The method of claim 1, further comprising:
sending, to the client device, a sensory feedback profile associated with the account identifier, wherein the sensory feedback profile is configured to provide a sensory feedback response upon interaction with each symbol of the plurality of starting symbols.

11. The method of claim 10, further comprising:
generating the sensory feedback profile; and
associating the sensory feedback profile with the account identifier, wherein the same sensory feedback profile is sent each time the account identifier is received by the authentication server.

12. The method of claim 11, wherein each symbol of the plurality of starting symbols is associated with interactive interface portion of a user input interface, and a different sensory feedback response is associated with each interactive interface portion.

13. The method of claim 11, wherein the same sensory feedback profile is used every time the device identifier indicates that the client device was previously associated with the account identifier.

14. The method of claim 11, wherein the sensory feedback response is one of a tactile response, a visual response, an audio response, or a combination of a tactile, a visual, or an audio response.

15. An authentication server, comprising:
a communication interface to receive an account identifier of a user from a client device; and
a processing circuit coupled to the communication interface, the processing circuit is configured to:
obtain a plurality of starting symbols associated with the account identifier, wherein the plurality of starting symbols are distinct for different account identifiers and the same plurality of starting symbols is obtained every time the same account identifier is received from the client device; and
send, to the client device, the plurality of starting symbols associated with the account identifier.

16. The authentication server of claim 15, wherein the processing circuit is further configured to:
receive a device identifier from the client device, wherein the plurality of starting symbols associated with the account identifier is only obtained if the device identifier was previously associated with the account identifier.

17. The authentication server of claim 15, wherein the processing circuit is further configured to:
send, to the client device, a plurality of new starting symbols if the device identifier indicates that the client device was previously unassociated with the account identifier.

18. The authentication server of claim 15, wherein the processing circuit is further configured to:
obtain, from the client device, a security code associated with the account identifier;
randomly generate the plurality of starting symbols while guaranteeing that the plurality of starting symbols is distinct from the security code; and
associate the plurality of starting symbols with the account identifier.

19. The authentication server of claim 15, wherein the processing circuit is further configured to:
send, to the client device, a sensory feedback profile associated with the account identifier, wherein the sensory feedback profile is configured to provide a sensory feedback response upon interaction with each symbol of the plurality of starting symbols.

20. The authentication server of claim 19, wherein the processing circuit is further configured to:
generate the sensory feedback profile; and
associate the sensory feedback profile with the account identifier, wherein the same sensory feedback profile is sent each time the account identifier is received by the authentication server.

21. The authentication server of claim 20, wherein each symbol of the plurality of starting symbols is associated with a different interactive interface portion of a user input interface, and a different sensory feedback response is associated with each interactive interface portion.

22. A method operational at a client device, comprising:
sending an account identifier of a user to an authentication server;
receiving a plurality of starting symbols associated with the account identifier, wherein the plurality of starting symbols are distinct for different account identifiers and the received plurality of starting symbols are the same every time the account identifier is sent from the client device; and
displaying the plurality of starting symbols within an interactive input interface to allow the user to select a security code.

23. The method of claim 22, wherein the interactive input interface is a rotating interface configured to individually change each symbol of the plurality of starting symbols upon interaction by a user.

24. The method of claim 22, further comprising:
gaining access to an account associated with the account identifier if the selected security code is successfully authenticated by the authentication server.

25. The method of claim 22, further comprising:
receiving, from the authentication server, a sensory feedback profile associated with the account identifier; and
providing a sensory feedback response according to the sensory feedback profile each time the user interacts with the interactive user interface to change one of the displayed starting symbols.

26. The method of claim 25, wherein the same sensory feedback profile is received by the client device every time a same device identifier and account identifier are sent to the authentication server.

27. The method of claim 25, wherein each symbol of the plurality of starting symbols is associated with a different interactive interface portion of a user input interface, and a different sensory feedback response is associated with each interactive interface portion.

28. A client device, comprising:
a display device;
a communication interface to communicate with an authentication server; and
a processing circuit coupled to the communication interface and the display device, the processing circuit configured to:
send an account identifier of a user to the authentication server;
receive a plurality of starting symbols associated with the account identifier, wherein the plurality of starting symbols are distinct for different account identifiers and the received plurality of starting symbols are the same every time the account identifier is sent from the client device; and
display, on the display device, the plurality of starting symbols within an interactive input interface to allow the user to select a security code.

29. The client device of claim 28, wherein the interactive input interface is a rotating interface configured to individually change each symbol of the plurality of starting symbols upon interaction by a user.

30. The client device of claim 28, wherein the processing circuit is further configured to:
receive, from the authentication server, a sensory feedback profile associated with the account identifier; and
provide a sensory feedback response according to the sensory feedback profile each time the user interacts with the interactive user interface to change one of the displayed starting symbols.
